(19) United States
(12) Patent Application Publication
(10) Pub. No.: US 2025/0252088 A1
(43) Pub. Date: Aug. 7, 2025

(54) MULTI-SOURCE HETEROGENEOUS DATA MANAGEMENT SYSTEM AND METHOD

(71) Applicant: Nanhu Laboratory, Jiaxing City (CN)

(72) Inventors: Tao ZHANG, Jiaxing City (CN); Hao Liu, Jiaxing City (CN); Zhefeng Liu, Jiaxing City (CN); Qi Wang, Jiaxing City (CN); Zhiling Chen, Jiaxing City (CN); Wei Chen, Jiaxing City (CN); Yinlong Liu, Jiaxing City (CN); Chenxi Yu, Jiaxing City (CN); Peng Wang, Jiaxing City (CN)

(21) Appl. No.: 19/035,186

(22) Filed: Jan. 23, 2025

(30) Foreign Application Priority Data
Feb. 4, 2024 (CN) 202410157429.5

(51) Int. Cl. G06F 16/22; G06F 16/2455; G06F 16/27

(52) U.S. Cl. CPC G06F 16/22; G06F 16/2456; G06F 16/27

(57) ABSTRACT

A multi-source heterogenous data management system and method are provided. The system includes a data source management module and a data acquisition module that are connected to each other. The data source management module is configured to classify multi-source heterogeneous data to obtain classified data sources, where the classified data sources include a structured data source, a semi-structured data souce, an unstructured data source, and a binary data source; and perform information configuration of a predetermined configuration rule on the classified data sources to obtain data source information, where the predetermined configuration rule includes a URL, a username, a password, and a driver. The data acquisition module is configured to query, retrieve, and read the data source information by using a predetermined data processing method, such as a batch data mode or a streaming data mode, to obtain read data.

### CROSS-REFERENCE TO RELATED PRESENT DISCLOSURE

This patent application claims the benefit and priority of Chinese Patent Application No. 2024101574295 filed with the China National Intellectual Property Administration on Feb. 4, 2024, the disclosure of which is incorporated by reference herein in its entirety as part of the application.

### TECHNICAL FIELD

The present disclosure relates to the field of data processing, and in particular to a multi-source heterogeneous data management system and method.

### BACKGROUND

In the era of big data, with the rapid development of technology such as the Internet, mobile Internet, and the Internet of Things, data is growing explosively at an unprecedented rate, and the data has diverse forms and sources. There is currently a lack of a convenient, efficient, scalable, and easy-to-operate platform for the acquisition, aggregation, query, and search of multi-source heterogeneous data. Therefore, it is crucial to design and develop a multi-source heterogeneous data management platform based on data lake technology.

### SUMMARY

An object of the present disclosure is to provide a multi-source heterogeneous data management system and method, which can process data efficiently and conveniently. To achieve the above object, the present disclosure provides the following solutions.

A multi-source heterogeneous data management system, includes a data source management module and a data acquisition module that are connected to each other, where
the data source management module is configured to:
classify multi-source heterogeneous data based on a simplified description abstraction algorithm to obtain classified data sources, where the classified data sources include a structured data source, a semi-structured data source, an unstructured data source, and a binary data source; and
perform information configuration of a predetermined configuration rule on the classified data sources to obtain data source information, where the predetermined configuration rule includes a Uniform Resource Locator (URL), a username, a password, and a driver; and
the data acquisition module is configured to query, retrieve, and read the data source information by using a predetermined data processing method, to obtain read data, where the predetermined data processing method includes a batch data mode and a streaming data mode.

In some embodiments, the system further includes a data storage module, where
the data storage module is connected to the data source management module and the data acquisition module;
the data storage module is configured to store the predetermined configuration rule and the data source information; and
the data storage module is further configured to store the read data.

In some embodiments, the system further includes a data query module, where
the data query module is connected to the data storage module; and
the data query module is configured to perform single-table query and multi-table joint query on the read data to obtain query data information, where the query data information includes a storage path and data details of the read data.

In some embodiments, the system further includes a statistical analysis module, where
the statistical analysis module is connected to the data source management module and the data acquisition module;
the statistical analysis module is configured to display statistical data, where the statistical data includes a destination of the multi-source heterogeneous data and a source of the read data; and
the statistical analysis module is further configured to perform causal analysis on the read data by calling a causal analysis algorithm to obtain analysis data, and display the analysis data.

In some embodiments, the data storage module includes a configured data lake format and underlying storage medium, where
the data lake format includes Delta Lake, Apache Hudi, and Apache Iceberg; and
the underlying storage medium includes Hadoop Distributed File System (HDFS), Amazon Web Services (AWS), and Ceph.

In some embodiments, the system further includes a task management module, where
the task management module is connected to the data source management module and the data acquisition module;
the task management module is configured to manage and set the data source information in the data source management module; and
the task management module is further configured to manage and allocate a query index of the data acquisition module.

A multi-source heterogeneous data management method, which is implemented using the foregoing system, includes:
classifying multi-source heterogeneous data based on a simplified description abstraction algorithm to obtain classified data sources, where the classified data sources include a structured data source, a semi-structured data source, an unstructured data source, and a binary data source;
performing information configuration of a predetermined configuration rule on the classified data sources to obtain data source information, where the predetermined configuration rule includes a URL, a username, a password, and a driver; and
querying, retrieving, and reading the data source information by using a predetermined data processing method, to obtain read data, where the predetermined data processing method includes a batch data mode and a streaming data mode.

In some embodiments, the method further includes storing the read data.

According to the specific embodiments provided by the present disclosure, the present disclosure discloses the following technical effects.

The present disclosure provides a multi-source heterogeneous data management system and method, in which a data source management module is configured to classify multi-source heterogeneous data based on a simplified description abstract algorithm, to obtain classified data sources; and perform information configuration of a predetermined configuration rule on the classified data sources to obtain data source information. The predetermined configuration rule includes a URL, a username, a password, and a driver. A data acquisition module is configured to query, retrieve, and read the data source information by using a predetermined data processing method, to obtain read data. Therefore, the data can be processed efficiently and conveniently.

### BRIEF DESCRIPTION OF THE DRAWINGS

In order to illustrate the technical solutions in embodiments of the present disclosure or in the prior art more clearly, a brief introduction to the accompanying drawings required for the embodiments will be provided below. Obviously, the accompanying drawings in the following description merely illustrates some of the embodiments of the present disclosure, and those of ordinary skill in the art can also obtain other drawings according to these drawings without involving any inventive effort.

FIG. 1 is a structural diagram of a multi-source heterogeneous data management system according to an embodiment of the present disclosure;

FIG. 2 is an architectural diagram of a multi-source heterogeneous data management system according to an embodiment of the present disclosure;

FIG. 3 is a schematic diagram of an interface of a statistical analysis module according to an embodiment of the present disclosure; and

FIG. 4 is a flowchart of a multi-source heterogeneous data management method according to an embodiment of the present disclosure.

### SYMBOL DESCRIPTION

Data source management module—1, data acquisition module—2, data storage module—3, data query module—4, statistical analysis module—5, and task management module—6.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the examples in the present disclosure, all the other examples that would have been obtained by those of ordinary skill in the art without involving any inventive effort shall fall within the scope of protection of the present disclosure.

An object of the present disclosure is to provide a multi-source heterogeneous data management system and method, which can process data efficiently and conveniently.

To make the above objective, features and advantages of the present disclosure clearer and more comprehensible, the present disclosure is further described in detail below with reference to the accompanying drawings and specific implementations.

### Embodiment 1

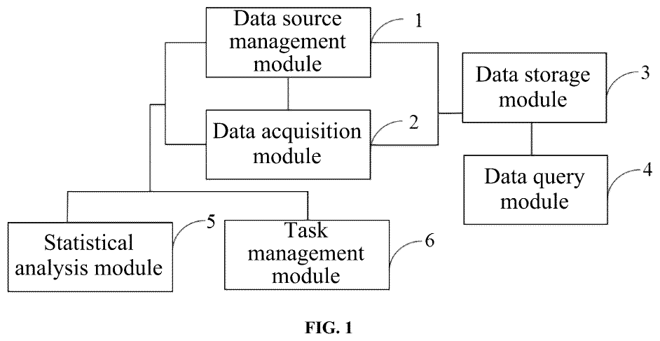

As shown in FIG. 1, an embodiment of the present disclosure provides a multi-source heterogeneous data management system. The system includes a data source management module 1 and a data acquisition module 2 that are connected to each other.

The data source management module 1 is configured to classify multi-source heterogeneous data based on a simplified description abstraction algorithm to obtain classified data sources. The classified data sources include a structured data source, a semi-structured data source, an unstructured data source, and a binary data source.

The data source management module 1 is further configured to perform information configuration of a predetermined configuration rule on the classified data sources to obtain data source information. The predetermined configuration rule includes a Uniform Resource Locator (URL), a username, a password, and a driver.

The data acquisition module 2 is configured to query, retrieve, and read the data source information by using a predetermined data processing method, to obtain read data. The predetermined data processing method includes a batch data mode and a streaming data mode.

The system further includes a data storage module 3.

The data storage module 3 is connected to the data source management module 1 and the data acquisition module 2.

The data storage module 3 is configured to store the predetermined configuration rule and the data source information.

The data storage module 3 is further configured to store the read data.

In one embodiment, the system further includes a data query module 4. The data query module 4 is connected to the data storage module 3. The data query module 4 is configured to perform single-table query and multi-table joint query on the read data to obtain query data information. The query data information includes a storage path and data details of the read data.

As an optional implementation, the system further includes a statistical analysis module 5. The statistical analysis module 5 is connected to the data source management module 1 and the data acquisition module 2.

The statistical analysis module 5 is configured to display statistical data. The statistical data includes a destination of the multi-source heterogeneous data and a source of the read data.

The statistical analysis module 5 is further configured to perform causal analysis on the read data by calling a causal analysis algorithm to obtain analysis data, and display the analysis data.

The data storage module 3 includes a configured data lake format and underlying storage medium.

The data lake format includes Delta Lake, Apache Hudi, and Apache Iceberg. The underlying storage medium includes Hadoop Distributed File System (HDFS), Amazon Web Services (AWS), and Ceph.

In addition, the system further includes a task management module 6.

The task management module 6 is connected to the data source management module 1 and the data acquisition module 2.

The task management module 6 is configured to manage and set the data source information in the data source management module. The task management module 6 is further configured to manage and allocate a query index of the data acquisition module 2.

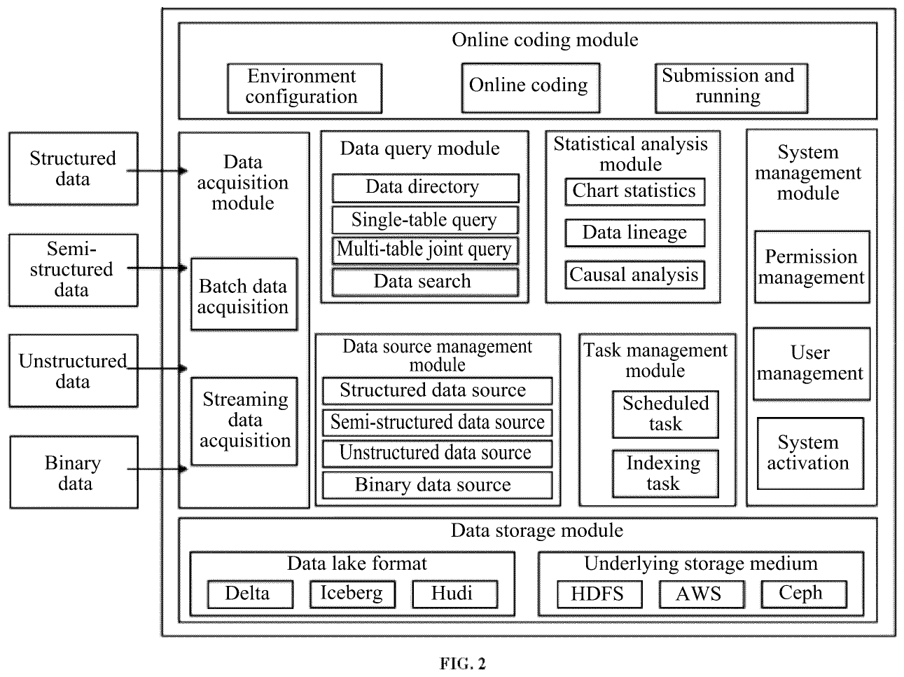

In practical applications, an architectural diagram of the multi-source heterogeneous data management system according to the present disclosure is as shown in FIG. 2.

The system management module includes system activation, user management, and permission management. The data source management module 1 includes management of the structured data source, the semi-structured data source, the unstructured data source, and the binary data source. The data acquisition module 2 includes batch data acquisition and streaming data acquisition. The data storage module 3 includes configuration of the data lake format and the underlying storage medium. The task management module 6 includes management of scheduled lake entry and exit tasks and management of data lake search and indexing tasks. The data query module 4 includes data directory, single-table query, multi-table query, and data search functions. The statistical analysis module 5 includes chart statistics, data lineage, and causal analysis functions. The online coding module includes environment configuration, online coding, and submission and running functions.

Specifically, details of the modules are described as follows.

1. System management module: For system activation, first, a user uses a super administrator account to log in to the system, at which time the system displays a status as inactive; then, the user sends a request code generated by the system containing unique information of a physical host to a relevant technician (authorizer), who then generates a license; and the user submits the license to the system for activation. Because the license includes the unique information of the physical host, consistency of the information will be checked during the activation process to ensure that the license will not be abused. User management supports functions such as creating, modifying, and logging out of users. Permission management supports configuration by a super administrator of module usage permissions for ordinary users, and supports configuration of permissions such as reading and writing data in a data lake.

About the system activation:

1) The system has a key pair including a private key and a public key. 2) The private key is owned by the authorizer, and the public key is given to the user. 3) The user sends the request code generated by the system containing the unique information of the physical host to the authorizer, and the authorizer uses the private key to generate a license signature certificate for authorization information such as an expiration date, a Media Access Control (MAC) address, etc. 4) The user submits the license signature certificate to the system, and the system uses the public key to verify the license signature certificate and is activated after verification.

2. Data source management module: Classifying multi-source heterogeneous data based on the simplified description abstraction algorithm is classifying multi-source heterogeneous data according to data structure or based on Abstract Data Type (ADT) technology, and the classified data sources comprise a structured data source, a semi-structured data source, an unstructured data source, and a binary data source. First, according to the basic idea of Abstract Data Type (ADT) (in which ADT refers to a mathematical model and a set of operations defined on the model, and this theory is used to simplify the description of abstract algorithms, classify and evaluate data structures, and formally describe programming languages), the multi-source heterogeneous data sources are classified into four types: the structured data source, the semi-structured data source, the unstructured data source, and the binary data source. Then, for each type of specific data source, configuration functions are provided. For example, for a MySQL data source that is a structured data source, configuration of information such as a URL, a username, a password, and a driver is provided. Once configured herein, the configuration may be used anywhere in the platform, reducing repeated input of data source information and improving efficiency.

The data source information (such as the URL, the username, the password, and the driver) is saved in a system database in the form of a page for the user to fill in.

3. Data acquisition module: The batch data acquisition uses the information configured in the above data source management module and adopts the batch processing mode to store data in a specified data source in batches into a data lake. The streaming data acquisition uses the information configured in the above data source management module and adopts the streaming processing mode to store newly added data in a specified data source into a data lake in real time.

About data acquisition:

For data entering lake in batches, first, the information configured in the data source management module needs to be selected. Then, a data lake path and some other lake entry parameters are added. Finally, a lake entry operation is performed. The system will read the data from a data source and then write the data into the data lake.

For data entering lake by streaming, first, a database configured in the data source management module is monitored in a polling manner. In each poll, a total number of data items in a specified database table is obtained and recorded.

Then, a difference between a result of a previous poll and the current result is calculated, and the difference is the number of items of incremental data.

Afterwards, using the result of the previous poll as an offset and the difference as an amount of data to be obtained, the table is queried.

Finally, the queried data is added to the data lake.

Through the above functions, incremental data, such as log records, may be streamed into the lake.

4. Data storage module: This module supports selection of the data lake format, and provides three mainstream international data lake formats: Delta Lake, Apache Hudi, and Apache Iceberg. Furthermore, the module supports selection of the underlying storage medium for the data lake, and provides HDFS, AWS, Ceph, etc. Before acquiring the data, the user needs to first configure the data lake format and underlying storage medium in this module. Storage modes in the data storage module include an overwrite mode and an append mode. The overwrite mode will overwrite existing data in the path with new data, and the append mode will append the new data to the end of the existing data.

Specifically, regarding the data storage, through interaction with the data lake via Spark's DataFrame interface, Delta Lake, Apache Hudi, and Apache Iceberg all provide a Spark's DataFrame interface access method. The system supports selection of the above three data lake formats.

The three supported data lakes may all store data in the form of Parquet files. The underlying storage media HDFS, AWS, and Ceph all support storage of Parquet files. The system supports selection of the above three underlying storage media.

5. Task management module: Operations such as a large amount of data entering and exiting the lake take a long time, and a front-end interface will wait for an overly long time, causing waiting timeouts and other issues. Asynchronous task execution is supported. To manage scheduled tasks of entering and exiting the lake, the user may create a scheduled task, specify a data source (configured in the above data source management module), a data lake storage path, and a scheduled time. The task may be a single task or a periodic task. Management of data lake search and indexing tasks implements a data search function in the data lake based on Elasticsearch, and supports creation of Elasticsearch indexes. The data is added to Elasticsearch by executing a corresponding index creation task, so as to support data search in the data query module.

6. Data query module: Query of data directories is supported. The data directory is automatically generated during data acquisition and displayed in a tree structure. For data stored in the data lake, various forms of single-table queries and multi-table joint queries are supported. In addition, the user may find a storage path and data details of required data through the data search function.

About the single-table query, this is query for only data in a single table in the data lake.

About the multi-table join query, for multiple related tables, such as table1 and table2, these two tables and their connected data field are selected, then data fields to be displayed are selected, and finally, a query operation is performed.

7. Statistical analysis module: Chart statistics support visualization methods such as tables, bar charts, pie charts, and line charts. A large-screen page in a dashboard displays data statistical information including a data update status and a data storage status, according to a time period set by the user. Data lineage visualizes a source and a destination of data in the data lake. The causal relationship is analyzed by calling an algorithm in Causal Discovery Toolbox (CDT), and the causal relationship is evaluated by calling an algorithm in DoWhy. The causal analysis algorithm is the algorithm in CDT, and the algorithm in CDT may be Partial Correlation (PC), Greedy Equivalence Search (GES), or Linear Non-Gaussian Acyclic Model (LINGAM).

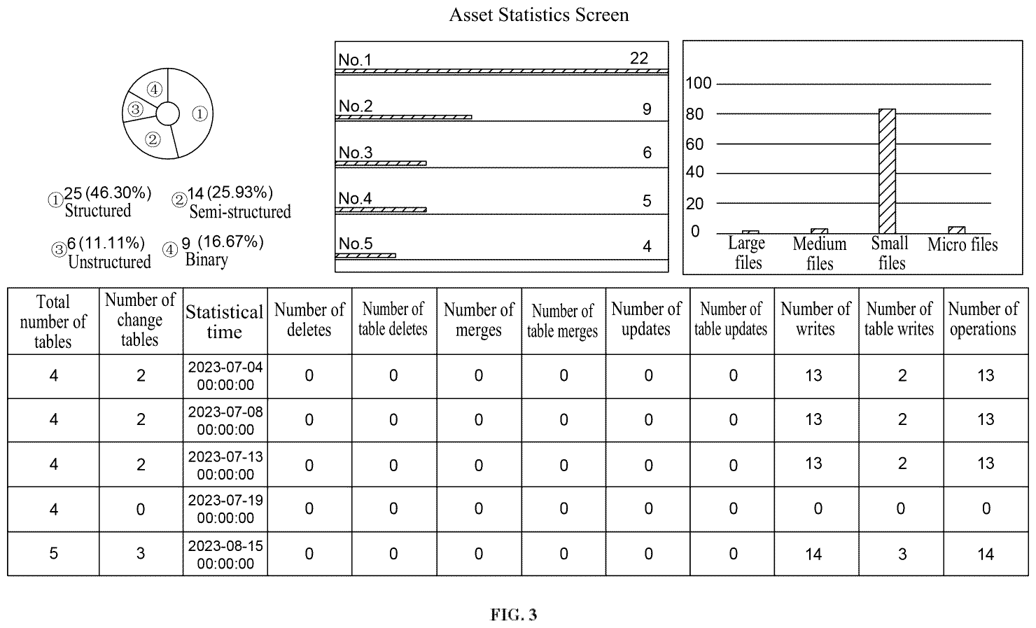

The statistics of data is completed by a back-end of the system, which then returns the statistical data to a front-end. The front-end displays the statistical data in various forms through drawing components supported by its framework. A schematic diagram of a display interface is shown in FIG. 3.

8. Online coding module: For more complex data acquisition or data processing, the system provides an online coding function. The user may configure a programming environment, then write user code, and finally submit the code to the system with one click. After running the code, the system returns a result. For environment configuration, before writing the online code, the user needs to set up the programming environment, which mainly includes information such as programming language (in which Java and Python are supported) and the number of concurrent threads. Then, the user uses the configured language for online coding, and the system checks the language in real time. Finally, the user submits the code to the system with one click. When the system runs the code, if an exception is encountered, the exception information is returned to the user. If everything is normal, the system will return the result to the user when the code is finished running.

### Embodiment 2

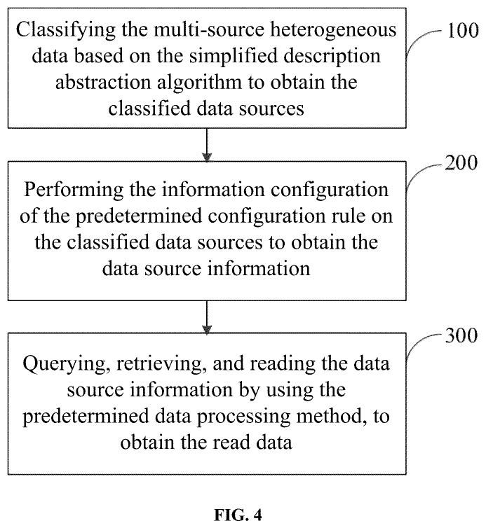

This embodiment of the present disclosure provides a multi-source heterogeneous data management method, which is implemented using the system in Embodiment 1. As shown in FIG. 4, the method includes steps 100-300.

In step 100, multi-source heterogeneous data is classified based on a simplified description abstraction algorithm to obtain classified data sources. The classified data sources include a structured data source, a semi-structured data source, an unstructured data source, and a binary data source.

In step 200, information configuration of a predetermined configuration rule is performed on the classified data sources to obtain data source information. The predetermined configuration rule includes a URL, a username, a password, and a driver.

In step 300, the data source information is queried, retrieved, and read by using a predetermined data processing method, to obtain read data. The predetermined data processing method includes a batch data mode and a streaming data mode.

In one embodiment, the method provided by this embodiment of the present disclosure further includes storing the read data.

The present disclosure has the following benefits:

Security: The system activation function is provided. Because the license includes the unique information of the physical host, it is guaranteed that the license will not be abused. In addition, permission configuration is provided for modules and data accessed by a user to ensure that the user can only use modules and data for which the user has permission, thereby enhancing security.

High efficiency: Through data source configuration, configuration may be performed once and used everywhere, thus improving operational efficiency. Through scheduled tasks, data acquisition is automated, greatly improving efficiency.

Scalability: The system has strong extensibility and adaptability to data sources, storage formats, and storage media, can flexibly respond to various changes and upgrades, and supports secondary development.

Convenience: Through the online coding module, a user may code at any place and any time without installing additional software or configuring a complex environment, eliminating some tedious steps in traditional coding methods. The online coding module provides instant feedback, which may help the user write code faster and reduce errors.

The various embodiments in this description are described in a progressive manner, and each embodiment focuses on differences from other embodiments. The same or similar parts between the various embodiments may refer to each other.

In the text, the principle and embodiments of the present disclosure are described herein by using specific examples, the above descriptions of the embodiments are merely intended to help understand the methods and core idea of the present disclosure. In addition, for those of ordinary skill in the art, changes may be made to the specific embodiments and the scope of application according to the concept of the present disclosure. In summary, the content of the description should not be construed as a limitation to the present disclosure.

What is claimed is:

1. A multi-source heterogeneous data management system, comprising: a data source management module and a data acquisition module that are connected to each other, wherein
the data source management module is configured to
classify multi-source heterogeneous data to obtain classified data sources, wherein the classified data sources comprise a structured data source, a semi-structured data source, an unstructured data source, and a binary data source; and
perform information configuration of a predetermined configuration rule on the classified data sources to obtain data source information, wherein the predetermined configuration rule comprises a Uniform Resource Locator (URL), a username, a password, and a driver; and
the data acquisition module is configured to query, retrieve, and read the data source information by using a predetermined data processing method, to obtain read data, wherein the predetermined data processing method comprises a batch data mode and a streaming data mode.

2. The multi-source heterogeneous data management system according to claim 1, wherein the system further comprises a data storage module, wherein
the data storage module is connected to the data source management module and the data acquisition module;
the data storage module is configured to store the predetermined configuration rule and the data source information; and
the data storage module is further configured to store the read data.

3. The multi-source heterogeneous data management system according to claim 2, wherein the system further comprises a data query module, wherein
the data query module is connected to the data storage module; and
the data query module is configured to perform single-table query and multi-table joint query on the read data to obtain query data information, wherein the query data information comprises a storage path and data details of the read data.

4. The multi-source heterogeneous data management system according to claim 1, wherein the system further comprises a statistical analysis module, wherein
the statistical analysis module is connected to the data source management module and the data acquisition module;
the statistical analysis module is configured to display statistical data, wherein the statistical data comprises a destination of the multi-source heterogeneous data and a source of the read data; and
the statistical analysis module is further configured to perform causal analysis on the read data by calling a causal analysis algorithm to obtain analysis data, and display the analysis data.

5. The multi-source heterogeneous data management system according to claim 2, wherein the data storage module comprises a configured data lake format and underlying storage medium, wherein
the data lake format comprises Delta Lake, Apache Hudi, and Apache Iceberg; and
the underlying storage medium comprises Hadoop Distributed File System (HDFS), Amazon Web Services (AWS), and Ceph.

6. The multi-source heterogeneous data management system according to claim 1, wherein the system further comprises a task management module, wherein
the task management module is connected to the data source management module and the data acquisition module;
the task management module is configured to manage and set the data source information in the data source management module; and
the task management module is further configured to manage and allocate a query index of the data acquisition module.

7. A multi-source heterogeneous data management method, wherein the method is implemented using the system according to claim 1; and the method comprises:
classifying the multi-source heterogeneous data to obtain the classified data sources, wherein the classified data sources comprise the structured data source, the semi-structured data source, the unstructured data source, and the binary data source;
performing the information configuration of the predetermined configuration rule on the classified data sources to obtain the data source information, wherein the predetermined configuration rule comprises the URL, the username, the password, and the driver; and
querying, retrieving, and reading the data source information by using the predetermined data processing method, to obtain the read data, wherein the predetermined data processing method comprises the batch data mode and the streaming data mode.

8. The multi-source heterogeneous data management method according to claim 7, wherein the method further comprises storing the read data.

9. The multi-source heterogeneous data management method according to claim 7, wherein the system further comprises a data storage module, wherein
the data storage module is connected to the data source management module and the data acquisition module;
the data storage module is configured to store the predetermined configuration rule and the data source information; and
the data storage module is further configured to store the read data.

10. The multi-source heterogeneous data management method according to claim 9, wherein the system further comprises a data query module, wherein
the data query module is connected to the data storage module; and
the data query module is configured to perform single-table query and multi-table joint query on the read data to obtain query data information, wherein the query data information comprises a storage path and data details of the read data.

11. The multi-source heterogeneous data management method according to claim 7, wherein the system further comprises a statistical analysis module, wherein
the statistical analysis module is connected to the data source management module and the data acquisition module;
the statistical analysis module is configured to display statistical data, wherein the statistical data comprises a destination of the multi-source heterogeneous data and a source of the read data; and
the statistical analysis module is further configured to perform causal analysis on the read data by calling a causal analysis algorithm to obtain analysis data, and display the analysis data.

12. The multi-source heterogeneous data management method according to claim 9, wherein the data storage module comprises a configured data lake format and underlying storage medium, wherein
the data lake format comprises Delta Lake, Apache Hudi, and Apache Iceberg; and
the underlying storage medium comprises Hadoop Distributed File System (HDFS), Amazon Web Services (AWS), and Ceph.

13. The multi-source heterogeneous data management method according to claim 7, wherein the system further comprises a task management module, wherein
the task management module is connected to the data source management module and the data acquisition module;
the task management module is configured to manage and set the data source information in the data source management module; and
the task management module is further configured to manage and allocate a query index of the data acquisition module.
